(19) United States
(12) Patent Application Publication
(10) Pub. No.: US 2017/0050209 A1
(43) Pub. Date: Feb. 23, 2017

(54) COATING SYSTEM FOR SUBSTRATE

(71) Applicant: Caterpillar Inc., Peoria, IL (US)

(72) Inventors: Joshua Fox, Dunlap, IL (US); Yiyang Liew, Peoria, IL (US)

(73) Assignee: Caterpillar Inc., Peoria, IL (US)

(21) Appl. No.: 15/343,697

(22) Filed: Nov. 4, 2016

(51) Int. Cl. B05C 13/00; B05C 5/02

(52) U.S. Cl. CPC B05C 13/00; B05C 5/022

(57) ABSTRACT

A coating system for a substrate is provided. The substrate has a first portion and a second portion. The coating system includes a base adapted to receive and rotate the substrate about an axis. The coating system also includes a nozzle adapted to deposit a material on a predefined location on the substrate. The coating system further includes a controller configured to receive a signal indicative of coating the first portion of the substrate with the material. The controller is configured to determine a parameter of the material. The controller is configured to determine a parameter of the predefined location. The controller is also configured to determine a parameter of the rotation of the base. The controller is further configured to selectively control the base and the nozzle to coat the first portion of the substrate with the material based on the received signal and the determined parameters.

### TECHNICAL FIELD

The present disclosure relates to a coating system for a substrate. More particularly, the present disclosure relates to the coating system for selectively coating a portion of the substrate.

### BACKGROUND

Generally, metallic surfaces of components are coated with a coating material, such as epoxies, acrylics, silicones, encapsulates, urethanes, adhesives, and so on, in order to provide sealing between mating parts, to protect the components against contamination, corrosion, and so on. During a coating process, the coating material may tend to flow away from a location where the coating material may be deposited to other portions of the component. The flow of the coating material may be due to various reasons such as gravity, viscosity of the coating material, excess deposition, inaccurate location of deposition, time required for curing, and so on.

However, in some applications, only a limited portion of the component may be required to be coated with the coating material while maintaining a remaining portion of the component as uncoated or exposed to the surrounding environment. In such situations, it may be difficult to control the flow of the coating material in the remaining portion of the component during the coating process. For example, in applications such as sensors, the coating material may have to be deposited on a body or a header portion of the sensor while maintaining a sensing element/chip of the sensor as uncoated.

U.S. Pat. No. 6,982,002 describes an apparatus for forming a coating film on a substrate by applying a coating liquid to the substrate. The apparatus includes a spin chuck for holding the substrate. The apparatus also includes a motor for rotating the spin chuck. The apparatus further includes a nozzle for dropping the coating liquid on a center surface of the substrate. The nozzle includes a spiral groove or a plurality of fins for giving a gyrating force to the dropped coating liquid.

### SUMMARY OF THE DISCLOSURE

In an aspect of the present disclosure, a coating system for a substrate is provided. The substrate has a first portion and a second portion adjacent to the first portion. The coating system includes a base adapted to receive the substrate. The base is adapted to rotate the substrate about an axis. The coating system also includes a nozzle adapted to deposit a material on a predefined location on the first portion of the substrate. The coating system further includes a controller communicably coupled to the base and the nozzle. The controller is configured to receive a signal indicative of coating the first portion of the substrate with the material. The controller is configured to determine a parameter of the material. The controller is configured to determine a parameter of the predefined location. The controller is also configured to determine a parameter of the rotation of the base. The controller is further configured to selectively control the base and the nozzle to coat the first portion of the substrate with the material based on the received signal and the determined parameters.

Other features and aspects of this disclosure will be apparent from the following description and the accompanying drawings.

### BRIEF DESCRIPTION OF THE DRAWINGS

FIG. 1 is a schematic representation of a coating system, according to one embodiment of the present disclosure;

FIG. 2 is a perspective view of an exemplary substrate, according to one embodiment of the present disclosure;

FIG. 3 is a schematic representation of working of the coating system of FIG. 1, according to one embodiment of the present disclosure;

FIG. 4 is another schematic representation of working of the coating system of FIG. 1, according to one embodiment of the present disclosure;

FIG. 5 is yet another schematic representation of working of the coating system of FIG. 1, according to one embodiment of the present disclosure; and

FIG. 6 is a flowchart illustrating a method of working of the coating system of FIG. 1, according to one embodiment of the present disclosure.

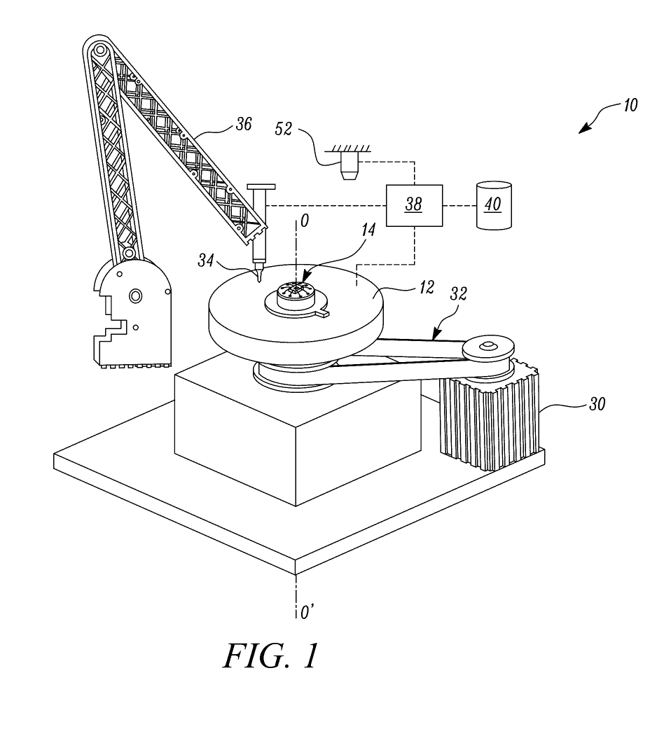

### DETAILED DESCRIPTION

Wherever possible, the same reference numbers will be used throughout the drawings to refer to the same or the like parts. Referring to FIG. 1, an exemplary coating system 10 is illustrated. The coating system 10 includes a base 12. In the illustrated embodiment, the base 12 has a circular configuration. In other embodiments, the base 12 may include any other configuration including, but not limited to, a rectangular configuration, a triangular configuration, and a hexagonal configuration.

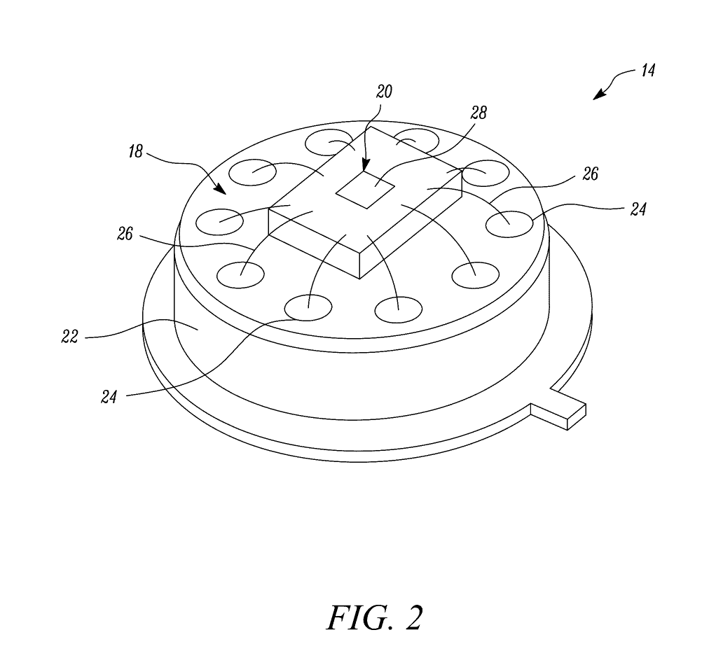

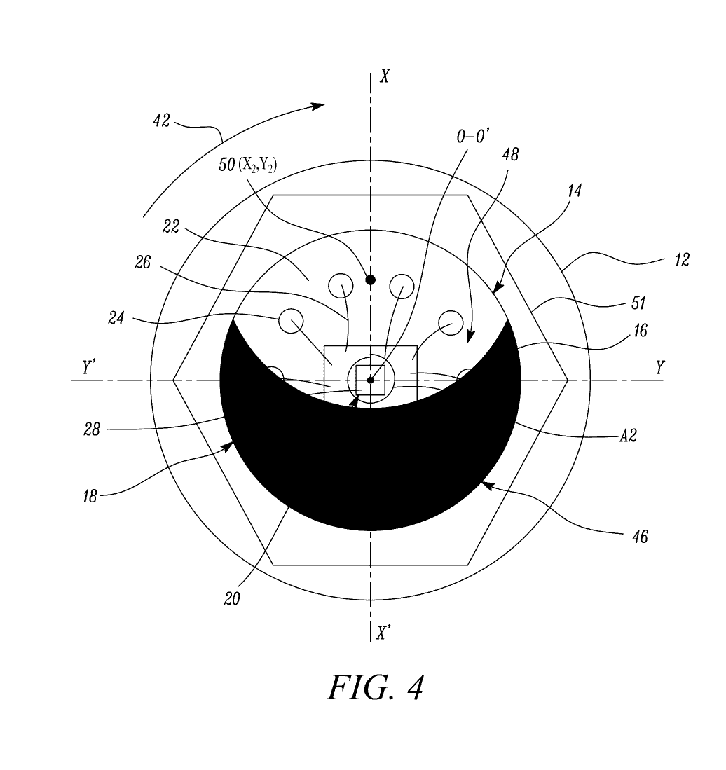

The base 12 is adapted to receive a substrate 14. More specifically, the base 12 is adapted to receive the substrate 14 for coating a portion of the substrate 14 with a material 16 (shown in FIG. 4). In the illustrated embodiment, the substrate 14 includes a gas sensor. In other embodiments, the substrate 14 may be any other sensor or component, such as a temperature sensor, a humidity sensor, a Printed Circuit Board (PCB), an Integrated Circuit (IC), and so on. The substrate 14 may be removably affixed to the base 12 using any coupling method including, but not limited to, clamping, bolting, and adhesion. The substrate 14 will be explained in more detail with reference to FIG. 2.

Referring to FIG. 2, the substrate 14 includes a first portion 18 and a second portion 20. The second portion 20 is adjacent to the first portion 18. The first portion 18 includes a portion of a header 22. The first portion 18 also includes a number of wire posts 24. Each of the wire post 24 is provided spaced apart from one another. The first portion 18 further includes a number of wire bonds 26. The second portion 20 includes a sensing element 28. The wire bonds 26 are coupled between the wire posts 24 and the sensing element 28. It should be noted that the first portion 18 and the second portion 20 described herein are merely exemplary. In other embodiments, the first portion 18 and/or the second portion 20 may include any predefined portion or components of the substrate 14 based on application requirements.

Referring to FIG. 1, the coating system 10 includes a motor 30 coupled to the base 12. In the illustrated embodiment, the motor 30 is coupled to the base 12 through a belt drive unit 32. In other embodiments, the motor 30 may be coupled to the base 12 using any other transmission unit, such as a gear, a clutch, and so on. Accordingly, the motor 30 is adapted to rotate the base 12 in turn rotating the substrate 14 received on the base 12 about an axis O-O′.

The coating system 10 includes a nozzle 34. The nozzle 34 is adapted to deposit the material 16 on a predefined location on the substrate 14. The material 16 may be any coating material known in the art including, but not limited to, epoxy, silicone, urethane, and acrylic, based on application requirements. The nozzle 34 may be any nozzle known in the art associated with any known material dispensing system. The coating system 10 also includes a robotic arm 36. The robotic arm 36 is adapted to receive the nozzle 34. The robotic arm 36 is also adapted to position the nozzle 34 in space around the substrate 14 in order to deposit the material 16 on the predefined location on the substrate 14.

Additionally, the coating system 10 may include a number of components (not shown) including, but not limited to, an enclosure, a predetermined environment within the enclosure, a conveying system, a material handling system, one or more sensors, image processing devices, and metrology equipment. It should be noted that the coating system 10 described herein is merely exemplary and may vary based on application requirements.

The coating system 10 also includes a controller 38. The controller 38 is communicably coupled to the base 12 and the nozzle 34. The controller 38 is configured to receive a signal indicative of coating the first portion 18 of the substrate 14 with the material 16. The controller 38 may receive the signal indicative of coating the first portion 18 of the substrate 14 with the material 16 from an operator (not shown). The signal may include one or more parameters including, but not limited to, topography of the first portion 18, an area of the first portion 18, coordinates of the first portion 18, contours of the first portion 18, a type of the material 16, and a thickness of the coating.

In some embodiments, the parameters, such as the topography of the first portion 18, the area of the first portion 18, the coordinates of the first portion 18, the contours of the first portion 18, the type of the material 16, the thickness of the coating, and so on may be stored in a database 40 or a memory (not shown) of the controller 38. In such a situation, the signal indicative of coating the first portion 18 of the substrate 14 with the material 16 may be indicative of initiation of a coating process.

Based on the received signal, the controller 38 is configured to determine a parameter of the material 16. The parameter of the material 16 includes the type of the material 16. In one embodiment, the controller 38 may receive the type of the material 16 based on the signal indicative of coating the first portion 18 of the substrate 14. In another embodiment, the controller 38 may determine the type of the material 16 based on a dataset stored in the database 40 or the memory of the controller 38.

The parameter of the material 16 includes an amount of the material 16 to be deposited in order to coat the first portion 18 of the substrate 14 with the material 16. The parameter of the material 16 also includes a temperature of the material 16. The parameter of the material 16 further includes a viscosity of the material 16. The controller 38 may determine the parameter of the material 16, such as the amount, the temperature, and/or the viscosity, based on a dataset stored in the database 40 or the memory of the controller 38. The dataset may include various values of the amount of the material 16 to be deposited for different values of the type, the temperature, and/or different values of the viscosity of the material 16.

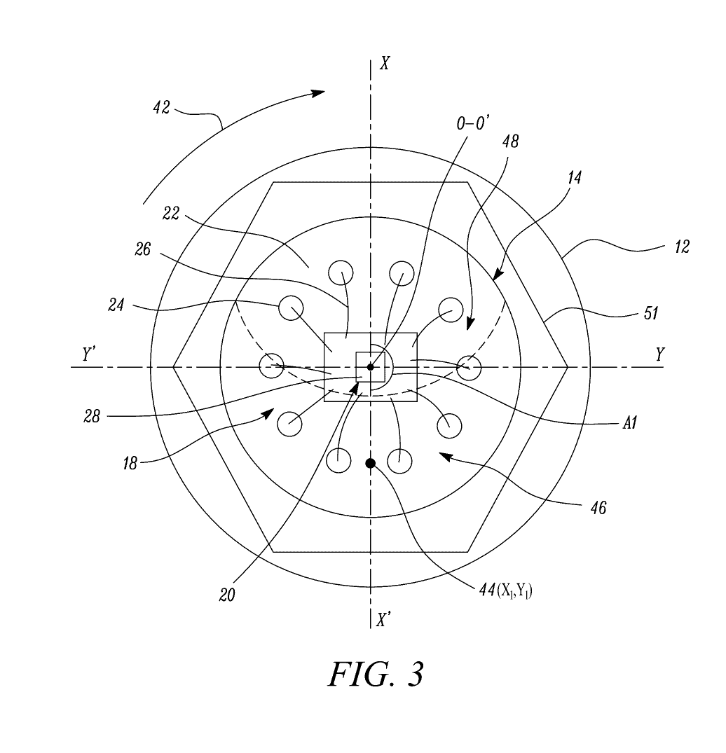

The controller 38 is also configured to determine a parameter of the predefined location. More specifically referring to FIG. 3, the predefined location is located on the first portion 18 of the substrate 14. Accordingly, the parameter of the predefined location includes coordinates of the predefined location with respect to axes X-X′ and Y-Y′. The parameter of the predefined location also includes the angle of rotation of the predefined location with respect to the axis X-X′. The controller 38 may determine the parameter of the predefined location based on a dataset stored in the database 40 or the memory of the controller 38. The dataset may include various values of the parameter of the predefined location for different values of the parameter of the material 16.

The controller 38 is further configured to determine a parameter of the rotation of the base 12. More specifically, the parameter of the rotation includes a speed of rotation. The parameter of the rotation also includes a direction 42 of rotation, such as a clockwise direction and an anticlockwise direction. The controller 38 may determine the parameter of the rotation of the base 12 based on a dataset stored in the database 40 or the memory of the controller 38. The dataset may include various values of the parameter of the rotation for different values of the parameter of the material 16 and/or the parameter of the predefined location.

Based on the received signal and the determined parameters, the controller 38 is configured to selectively control the base 12 and the nozzle 34 to coat the first portion 18 of the substrate 14 with the material 16. More specifically, the controller 38 is configured to control the nozzle 34 in order to control the determined amount of the material 16 to be deposited on the first portion 18 to coat the first portion 18 based on the type, the viscosity and/or the temperature of the material 16.

Also, the controller 38 is configured to control the nozzle 34 in order to deposit the determined amount of the material 16 at the predefined location on the first portion 18 of the substrate 14 based on the type, the viscosity and/or the temperature of the material 16. Further, the controller 38 is configured to control the base 12 in order to rotate the base 12 at the determined speed and in the determined direction 42 in order to impart centripetal force to the material 16 deposited on the predefined location. The centripetal force further spreads the material 16 away from the predefined location over the first portion 18 of the substrate 14.

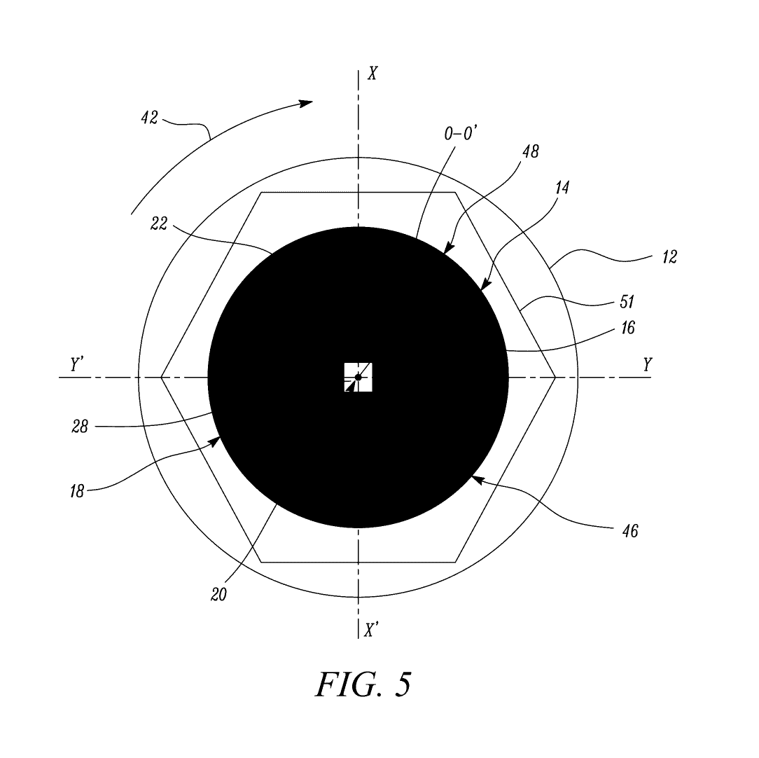

For example, as shown in FIGS. 3 to 5, based on the type, the viscosity and/or the temperature of the material 16, the controller 38 controls the nozzle 34 to deposit the determined amount of the material 16 at an exemplary first predefined location 44 on the first portion 18 of the substrate 14. The first predefined location 44 includes parameters such as first coordinates (X₁, Y₁) with respect to the axes X-X′ and Y-Y′, and a first angle of rotation A1 with respect to the axis X-X′ determined by the controller 38. Further, the controller 38 controls the rotation of the base 12 and in turn the substrate 14 at the determined speed and in the determined direction 42 in order to impart centripetal force to the deposited material 16.

In the illustrated embodiment, the centripetal force spreads the material 16 over a first section 46 of the first portion 18. As a result, a second section 48 of the first portion 18 remains uncoated with the material 16. Accordingly, the controller 38 controls the nozzle 34 to deposit another determined amount of the material 16 at an exemplary second predefined location 50 on the first portion 18 of the substrate 14, based on the type, the viscosity and/or the temperature of the material 16.

The second predefined location 50 includes parameters such as coordinates (X₂, Y₂) with respect to the axes X-X′ and Y-Y′, and a second angle of rotation A2 with respect to the axis X-X′ determined by the controller 38. Further, the controller 38 controls the rotation of the base 12 and in turn the substrate 14 at another determined speed and in the determined direction 42 in order to impart centripetal force to the deposited material 16. As a result, the centripetal force spreads the material 16 over the second section 48 of the first portion 18 in turn coating the complete first portion 18 of the substrate 14 with the material 16 while maintaining the second portion 20, including the sensing element 28, as uncoated.

It should be noted that, in one situation, the controller 38 may control the robotic arm 36 in order to position the nozzle 34 with respect to the first predefined location 44 and/or the second predefined location 50. In another situation, the controller 38 may control the base 12 in order to position the first predefined location 44 and/or the second predefined location 50 with respect to the nozzle 34. In such a situation, the position of the nozzle 34 may remain unchanged while depositing the material 16 at the first predefined location 44 and/or the second predefined location 50.

Also, in the illustrated embodiment, the first portion 18 is coated using sequential deposition of the material 16 at the first predefined location 44 and the second predefined location 50. In other embodiments, the first portion 18 may be coated using sequential deposition of the material 16 at one or more predefined locations based on application requirements. In yet other embodiments, the first portion 18 may be coated using continuous deposition of the material 16 at one or more predefined locations based on application requirements and without limiting the scope of the disclosure.

Additionally, the coating system 10 includes a housing 51. The housing 51 is provided on the base 12 and surrounding the substrate 14. In the illustrated embodiment, the housing 51 includes a hexagonal configuration. In other embodiments, the housing 51 may include any other configuration, such as a circular configuration, a pentagonal configuration, and so on, based on application requirements. Also, the housing 51 may be made of any material, such as polymer, metal, glass, and so on.

During the rotation of the base 12, a portion of the material 16 may be thrown off the substrate 14 due to centrifugal force acting on the material 16. The housing 51 provides a surface to limit spread of the material 16 thrown off the substrate 14. More specifically, the housing 51 provides a barrier to contain the thrown off material 16 therein. Also, the housing 51 provides a counter force to the thrown off material 16. As such, the thrown off material 16 may contact the housing 51 and may be directed back towards the substrate 14 due to the counter force provided by the housing 51.

Further, the coating system 10 includes a curing element 52 (shown in FIG. 1) communicably coupled to the controller 38. The curing element 52 is adapted to cure the material 16 deposited on the first portion 18 in a predefined amount of time. The curing element 52 may be any curing element known in the art such a heating device, an Ultra Violet (UV) lamp, and so on based on application requirements. The controller 38 is configured to control the curing element 52 based on a dataset stored in the database 40 or the memory of the controller 38. The dataset may include various values of an intensity and/or a duration of operation of the curing element 52 based on different values of the parameter of the material 16 and the required thickness of the coating.

### INDUSTRIAL APPLICABILITY

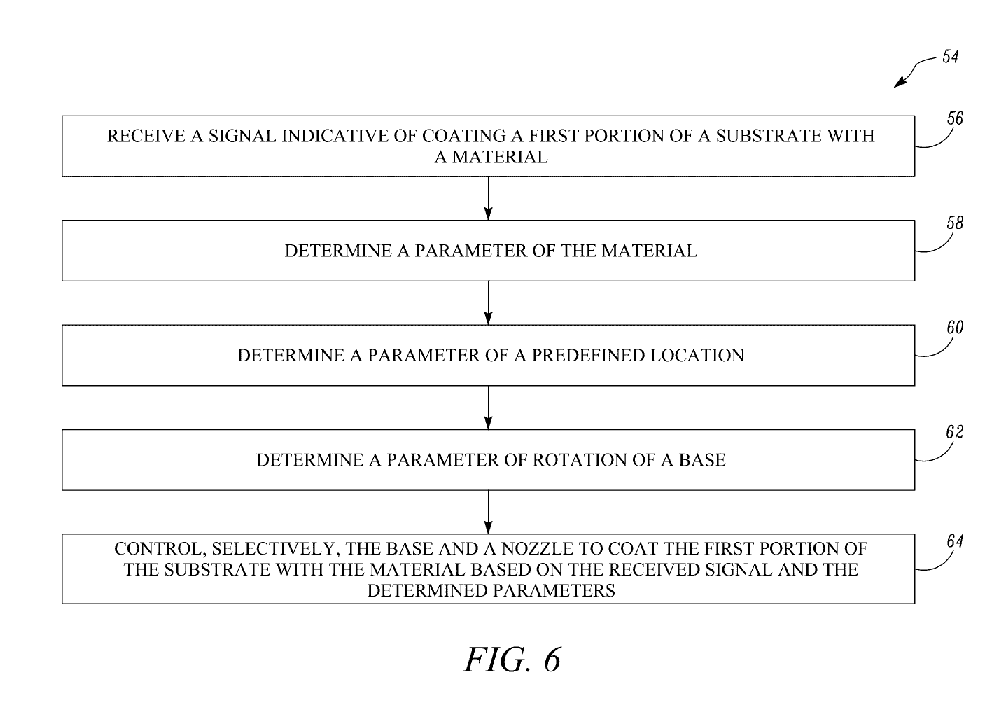

The present disclosure relates to a method 54 of working of the coating system 10 for coating the first portion 18 of the substrate 14 with the material 16. Referring to FIG. 6, a flowchart of the method 54 is illustrated. At step 56, the controller 38 receives the signal indicative of coating the first portion 18 of the substrate 14 with the material 16. The signal may include one or more parameters including, but not limited to, the topography of the first portion 18, the area of the first portion 18, the coordinates of the first portion 18, the contours of the first portion 18, the type of the material 16, and/or the thickness of the coating.

At step 58, the controller 38 determines the parameter of the material 16. The parameter of the material 16 includes the type of the material 16, the amount of the material 16 to be deposited, the temperature of the material 16, and/or the viscosity of the material 16. The controller 38 determines the parameter of the material 16 based on the dataset stored in the database 40 or the memory of the controller 38.

At step 60, the controller 38 determines the parameter of the predefined location. The parameter of the predefined location includes the coordinates and the angle of rotation of the predefined location with respect to the axes X-X′and Y-Y′. The controller 38 determines the parameter of the material 16 based on the dataset stored in the database 40 or the memory of the controller 38. At step 62, the controller 38 determines the parameter of the rotation of the base 12. The parameter of the rotation includes the speed of rotation and the direction 42 of rotation. The controller 38 determines the parameter of the rotation based on the dataset stored in the database 40 or the memory of the controller 38.

At step 64, based on the received signal and the determined parameters, the controller 38 selectively controls the base 12 and the nozzle 34 to coat the first portion 18 of the substrate 14 with the material 16. More specifically, the controller 38 controls the nozzle 34 in order to control the determined amount of the material 16 to be deposited on the first portion 18 to coat the first portion 18 based on the type, the viscosity and/or the temperature of the material 16.

The controller 38 also controls the base 12 in order to rotate the base 12 and in turn the substrate 14 to impart centripetal force to the material 16 deposited on the predefined location. The centripetal force further spreads the material 16 deposited at the predefined location over the first portion 18 of the substrate 14 without spreading the material 16 over the second portion 20 including the sensing element 28. Further, the controller 38 controls the curing element 52 based on the dataset in order to cure the material 16 spread over the first portion 18 of the substrate 14.

It should be noted that the curing element 52 may be controlled in any order by the controller 38 in order to cure the material 16 spread over the first portion 18 of the substrate 14. More specifically, in some embodiments, the curing element 52 may be controlled sequentially in order to cure the material 16 deposited over the first section 46 before depositing the material 16 over the second section 48. Further, the curing element 52 may be again controlled post deposition of the material 16 over the second section 48 in order to cure the material 16 deposited thereon. As such, the coating process may include deposition of the material 16 over the first section 46, curing of the material 16 spread over the first section 46 using the curing element 52, deposition of the material 16 over the second section 48, and curing of the material 16 spread over the second section 48 using the curing element 52.

In other embodiments, the curing element 52 may be controlled after deposition and spread of the material 16 over both the first section 46 and the second section 48 in order to simultaneously cure the material 16 deposited over the first portion 18. Further, in embodiments requiring multiple layers of coating, the curing element 52 may be controlled sequentially in order to cure multiple layers of the material 16 deposited sequentially on the first section 46, the second section 48, and/or the complete first portion 18.

The coating system 10 provides a simple, effective, and cost efficient method 54 of coating the first portion 18 of the substrate 14 with the material 16. The coating system 10 provides precisely controlling the base 12 and/or the nozzle 34 in order to coat the first portion 18 of the substrate 14 with the material 16 while limiting a spread of the material 16 over the second portion 20. Also, the coating system 10 provides to limit the spread of the material 16 over the second portion 20 by accurately controlling the curing element 52.

More specifically, in the illustrated embodiment, the coating system 10 provides to coat the portion of the header 22, the wire posts 24, and the wire bonds 26 of the first portion 18 with the material 16 while maintaining the sensing element 28 of the second portion 20 as uncoated. In other embodiments, the coating system 10 may be easily modified to coat a required portion of the substrate 14 with the material 16 while maintaining a remaining portion of the substrate 14 as uncoated. Further, the housing 51 provides to direct the material 16 thrown off the substrate 14, during the rotation thereof, back on the substrate 14 by providing the counter force to the thrown off material 16. Accordingly, the housing 51 provides to improve the thickness of the coating while limiting wastage of the material 16.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. A coating system for a substrate, the substrate having a first portion and a second portion adjacent to the first portion, the coating system comprising:
a base adapted to receive the substrate, the base adapted to rotate the substrate about an axis;
a nozzle adapted to deposit a material on a predefined location on the first portion of the substrate; and
a controller communicably coupled to the base and the nozzle, the controller configured to:
receive a signal indicative of coating the first portion of the substrate with the material;
determine a parameter of the material;
determine a parameter of the predefined location;
determine a parameter of the rotation of the base; and
control, selectively, the base and the nozzle to coat the first portion of the substrate with the material based on the received signal and the determined parameters.

2. The coating system of claim 1, wherein the signal indicative of coating includes at least one of topography of the first portion and a thickness of the coating.

3. The coating system of claim 1, wherein the parameter of the material is at least one of a type, an amount, a temperature, and a viscosity of the material.

4. The coating system of claim 1, wherein the parameter of the predefined location is at least one of a coordinate and an angle of rotation of the predefined location with respect to an axis.

5. The coating system of claim 1, wherein the parameter of the rotation is at least one of a direction of rotation and a speed of rotation.

6. The coating system of claim 1, wherein the controller further includes controlling a curing element to cure the material coated on the first portion of the substrate.

7. The coating of system of claim 1, further including a housing provided around the substrate.
